(19) United States
(12) Patent Application Publication
(10) Pub. No.: US 2007/0258527 A1
(43) Pub. Date: Nov. 8, 2007

(54) Fast Dynamic Noise Detection/Adaptation System For DSL Modems

(75) Inventors: Victor Simileysky, San Jose, CA (US); Amir H. Fazlollahi, San Jose, CA (US)

Correspondence Address: FENWICK & WEST LLP, SILICON VALLEY CENTER, 801 CALIFORNIA STREET, MOUNTAIN VIEW, CA, 94041, US

(73) Assignee: Centillium Communications, Inc., Fremont, CA (US)

(21) Appl. No.: 11/745,333

(22) Filed: May 7, 2007

Related U.S. Application Data
(60) Provisional application No. 60/798,864, filed on May 8, 2006.

(51) Int. Cl. H04L 27/28

(52) U.S. Cl. 375/260

(57) ABSTRACT

A systems and a method for a DMT-based DSL modem to detect time-varying noise dynamically during transmission and adapt to its rapid changes promptly by increasing or reducing data rate while maintaining the transmission and utilizing maximum channel capacity. A DMT-based modem reserves a first set of sub-channels to detect and measure the time-varying noise. The modem further provides reliable communications for control messages through a second set of sub-channels. The control messages are used to adjust communication to adapt to the new noise conditions over all sub-channels.

### CROSS-REFERENCE To RELATED APPLICATIONS

This application claims the benefit of U.S. Provisional Patent Application Ser. No. 60/798,864, entitled “A Fast Dynamic Noise Detection/Adaptation System For DSL Modems,” by Victor Simileysky and Amir Fazlollahi, filed on May 8, 2006, which is hereby incorporated by reference in its entirety.

### BACKGROUND

1. Field of the Invention

The present invention relates in general to broadband communication systems, and in particular to noise detection and adaptation in broadband communication.

2. Background of the Invention

The introduction of new services such as high-definition TV and life-line services demand highly robust data communication connection with very high data rate. A family of Digital Subscriber Line (DSL) technologies has been developed to meet this demand. Examples of such DSL technologies include Asymmetric DSL (ADSL) and Very High Speed DSL (VDSL). These technologies offer high data rate by utilizing unused frequency band(s) (or spectrum) of ordinary telephone lines. For example, VDSL can provide a peak data transmission rate of over 100 Mb/s by using frequency bands as wide as 30 MHz. DSL technologies often apply multi-carrier modulation technology such as Discrete Multitone Modulation (DMT). Multi-carrier modulation divides the transmission frequency band into multiple sub-channels (or modulation tones, sub-carriers), with each sub-channel individually modulating one or more bits of data.

The most common source of time-varying (or non-stationary, dynamic) disturbance in DSL systems is crosstalk disturbance (also known as crosstalk noise) from nearby communication systems. DSL systems typically transmit data over phone lines (e.g., twisted pairs) packed together in transmission lines (e.g., telephone cables). Therefore, signals carried in one phone line (the disturbing line) can cause electromagnetic interference in signals carried in other phone lines (the disturbed lines). For example, a change of status of a single phone line within a transmission line from inactive to active and vice versa creates a crosstalk noise in other phone lines within the same transmission line. Because the noise power (or noise level) of crosstalk noise increases with frequency, it is exceedingly an issue for DSL technologies that use high frequency bands to transmit data, such as ADSL and VDSL.

To overcome the crosstalk noise, a DMT-based DSL modem sets a Signal-to-Noise Ratio (SNR) margin to each sub-channel when establishing a DSL connection. The SNR margin is a measure of a communication system's immunity to noise. It represents the level of additional noise that the system can tolerate before violating the required bit error rate (BER) of the system. Therefore, as long as the crosstalk noise is within the SNR margin, the communication system can work properly. Because the noise power and frequency distribution of crosstalk noise change over time, the SNR margins of the sub-channels of a DSL connection may become undesirable and need adjustment.

One conventional approach to adjusting the SNR margins is applying conventional adaptation algorithms such as Seamless Rate Adaptation (SRA) method. These adaptation algorithms determine the noise power and frequency distribution and adjust the SNR margins accordingly.

The conventional adaptation algorithms are too slow to react to crosstalk noise changes. The power level of crosstalk noise can rise rapidly. These algorithms observe the communications in each sub-channel and determine an SNR margin for the sub-channel. Because the number of sub-channels can be substantial (up to 4,096 for VDSL) and each sub-channel may load substantial amount of information, the calculation for the SNR margins can be intensive and time-consuming. As a result, the crosstalk noise can increase tremendously and may well exceed the SNR margins before the DSL modem reacts, forcing the connection to drop. Reestablishing the connection in the disturbed line can take a significant amount of time (e.g., ten seconds for VDSL), which is unacceptable for many data services such as Voice over IP (VoIP). Some adaptation algorithms set high SNR margins to prevent connection drops. However, this approach highly penalizes the data rate of the connection.

Therefore, there is a need for systems and methods that can detect and adapt to time-varying noises promptly in a broadband communication system.

### SUMMARY OF THE INVENTION

The present invention specifically addresses the above-mentioned need. The present invention describes systems and methods for a DMT-based DSL modem to detect time-varying noise dynamically during transmission and adapt to its rapid changes promptly by increasing or reducing data rate while maintaining the transmission and utilizing maximum channel capacity. The DSL modem reserves a first set of sub-channels to detect and measure the time-varying noise. The DSL modem further provides reliable communications for control messages through a second set of sub-channels. The control messages are used to adjust communication to adapt to the new noise conditions over all sub-channels.

The present invention further describes methods to allocate the first set of sub-channels across the transmission frequency band(s) used for transmission to improve quality of the noise detection and measurement and minimize false detection with presence of other types of noise.

### BRIEF DESCRIPTION OF THE DRAWINGS

The invention is illustrated by way of example, and not by way of limitation, in the figures of the accompanying drawings in which like reference numerals refer to similar elements.

FIG. 1 illustrates a system for providing DMT-based DSL services with fast and reliable time-varying noise detection and adaptation, according to one embodiment of the invention.

FIGS. 2A and 2B are Quadrature Amplitude Modulation (QAM) data location diagrams of a 4-bit QAM system illustrating a signal being distorted by noise during transmission, according to one embodiment of the invention.

### DETAILED DESCRIPTION

The present invention describes systems and methods for a DMT-based communication system to detect time-varying noise dynamically during transmission using a first set of sub-channels and adapt to its abrupt changes promptly by increasing or reducing data rate while maintaining the transmission and utilizing maximum channel capacity.

Overview of System Architecture

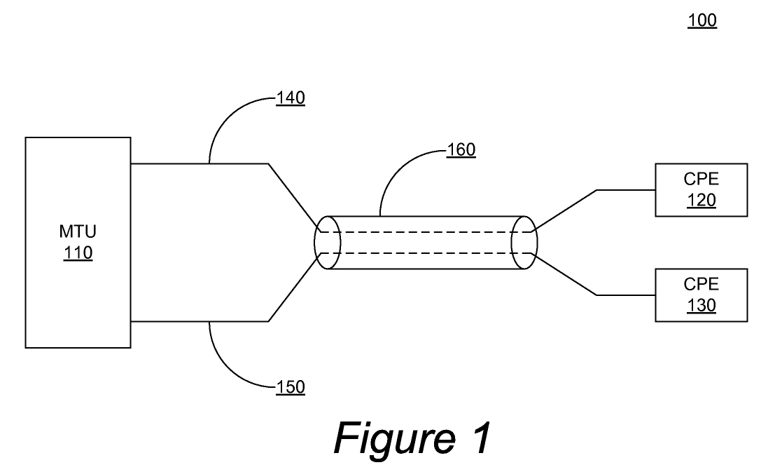

FIG. 1 is a high-level block diagram of a system 100 for providing DMT-based DSL services with fast and reliable noise detection and adaptation according to one embodiment of the present invention. The system 100 includes a Multi-Tenant Unit (MTU) 110 and two Customer Premises Equipments (CPEs) 120 and 130. The MTU 110 and the CPE 120 are connected through a phone line 140. The MTU 110 and the CPE 130 are connected through a phone line 150. The phone lines 140 and 150 are bundled in a transmission line 160.

The phone lines 140 and 150 can be any electrical signaling medium connecting the MTU 110 and the CPEs 120 and 130. One example of the signal medium is a pair of wires twisted about one another (twisted pair). The transmission line 160 is one, two or more wires bound together, typically in a common protective jacket or sheath. One example of the transmission line 160 is a phone cable. Even though only the phone lines 140 and 150 are shown, the transmission line can bundle many phone lines together. Because the phone lines 140 and 150 are proximate to each other, the signals carried in one phone line may cause electromagnetic interference (crosstalk noise) in the signals carried in the other phone line and vice versa.

The MTU 110 provides connections to the CPEs 120 and 130 through the phone lines 140 and 150. The MTU 110 can be a network device (e.g., a network switch) placed by a DSL service provider in a building where several customers of that service provider are located. The CPEs 120 and 130 are terminal equipments located on the customer premises connecting to the MTU 110 through the phone lines 140 and 150 and communicate with the MTU 110 using the DSL service. The MTU 110 and the CPEs 120 and 130 are equipped with DMT-based modems that divide the transmission frequency band(s) into multiple sub-channels and communicate through the sub-channels.

In one embodiment, the MTU 110 and the CPEs 120 and 130 reserve a set of sub-channels to detect and measure time-varying noise (monitoring sub-channels, also known as monitoring tones) and a set of sub-channels to provide reliable communications for control messages (reliable sub-channels). Specifically, the MTU 110 and the CPE 120 allocate a set of downstream sub-channels for the CPE 120 to monitor time-varying noise affecting the signals sent from the MTU 110 on the line 140 (downstream monitoring sub-channels), a set of upstream sub-channels for the CPE 120 to send control messages to the MTU 110 to adjust data transmission to the CPE 120 (upstream reliable sub-channels), a set of upstream sub-channels for the MTU 110 to monitor time-varying noise affecting the signals sent from the CPE 120 on the line 140 (upstream monitoring sub-channels), and a set of downstream sub-channels for the MTU 110 to send control messages to the CPE 120 to adjust data transmission to the MTU 110 (downstream reliable sub-channels). Similarly, the MTU 110 and the CPE 130 allocate downstream monitoring sub-channels, upstream reliable sub-channels, upstream monitoring sub-channels, and downstream reliable sub-channels for the data transmission in between. Downstream sub-channels are the sub-channels used by the MTU 110 to transmit data to the CPEs, and upstream sub-channels are those used by the CPEs to transmit data to the MTU 110. The downstream monitoring sub-channels and the downstream reliable sub-channels may have at least one sub-channel in common, and the upstream monitoring sub-channels and the upstream reliable sub-channels may have at least one sub-channel in common. These allocations can occur when the connection is first established. Alternatively, the MTU 110 and the CPEs 120 and 130 can allocate these sub-channels and modify the allocations during transmission.

In one embodiment, the MTU 110 and a CPE (120 or 130) establish two separate channels for communication, a primary channel and a secondary channel. The secondary channel comprises the reliable sub-channels and the primary channel comprises the rest sub-channels. The secondary channel is designed to provide reliable communication services and can be used to transmit information such as control messages related to the transmission between the MTU and the CPE. The primary channel can be used to transmit everything else.

Detection and Measurement of Time-Varying Noise

The present invention detects and measures time-varying noise through monitoring sub-channels. The monitoring sub-channels are only a small portion of the sub-channels in the transmission frequency band(s) and spread across the band(s). The monitoring sub-channels are loaded with noise margins higher than noise margins on sub-channels of the primary channel.

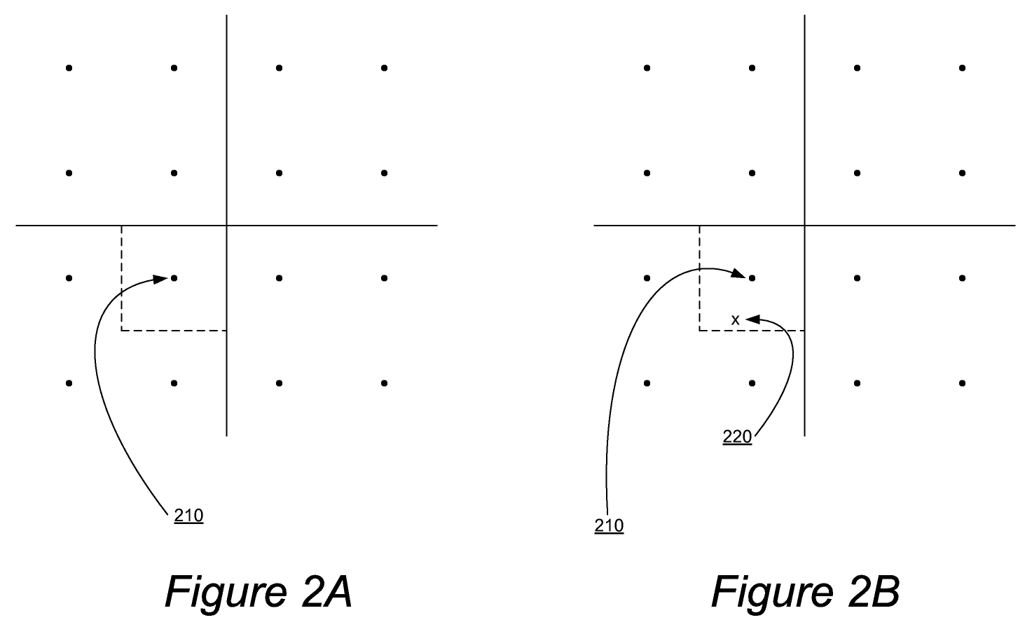

A transmitter (the MTU 110 or a CPE) breaks data to be transmitted into symbols (also known as signals and tones), and uses Quadrature Amplitude Modulation (QAM) to represent the symbols as complex numbers and modulate cosine and sine carrier signals with the real and imaginary parts. The symbols are then transmitted to a receiver (the MTU 110 or a CPE) with the carrier signals. The receiver receives the carrier signals, demodulates them to obtain the symbols. A symbol can carry a specified amount of bits, which is often referred to as the data rate of the sub-channel carrying the symbol. As the symbols are represented as complex numbers, they can be visualized as points on the complex plane. FIG. 2A is a 4-bit QAM data location diagram (also known as constellation diagram). A symbol of 4 bits can have sixteen distinctive values (also known as modulation alphabets). The 16 values can be mapped to 16 complex numbers represented by the sixteen points (constellation points) in the diagram. As an example, a value can be mapped to the point 210, modulated into carrier signals and sent over a corresponding sub-channel to a receiver.

Noise can disturb digitally modulated signals during analog transmission. Therefore, the signals received by the receiver are typically distorted. The demodulator of the receiver has access to the same constellation of points as the modulator of the transmitter. It finds the constellation point that is closest to the received signal, and uses this point to maps back to the symbols loaded in the sub-channel. The output of the receiver is a reconstructed data value. FIG. 2B is a 4-bit QAM data location diagram graphically represent the distortion of the signal mapped to point 210 as illustrated in FIG. 2A. The square formed by dotted lines and the axes represents a region where points are at closer distance to the point 210 than to any other constellation point. Because the received signal 220 is within the square, its closest constellation point is the point 210. Thus, the receiver correctly maps the signal 220 back to the corresponding symbol value.

Noise with high noise power distorts the signal further from its associated constellation point. Therefore, the receiver can measure the distance between the signal and the closest constellation point to determine the noise power in the corresponding monitoring sub-channel. The noise power may be estimated through statistical functions such as the noise distribution function (or distortion distribution function) which is calculated statistically by averaging distortions across multiple symbols. These statistical methods become inefficient and/or inaccurate in cases of strong noise that result in negative SNR margin. The receiver can further compare the noise power with the noise power determined previously, thereby determining the changes of the noise power over time. The receiver can further determine the SNR based on the measured noise power and the symbol energy.

The monitoring sub-channels assume noise margins (e.g., SNR margins) higher than noise margins of the sub-channels of the primary channel. In one embodiment, one or more of the monitoring sub-channels have a constellation size of 2-bit or smaller. As described above, the receiver demodulates received signals by finding the closest constellation points. Consequently, a powerful noise can disturb the signals and cause the receiver to demodulate incorrectly. By having a high noise margin in the monitoring sub-channel, the receiver can estimate noise power and distribution more accurately and/or more rapidly. Because statistical methods of noise estimation are efficient in cases where noises do not exceed the noise margin, the higher noise margins of the monitoring sub-channels enable more accurate and/or faster estimation of noises compare to sub-channels with lower noise margins.

The noise power of a time-varying noise typically does not change abruptly across the frequency spectrum. As noted above, the most common time-varying noise is crosstalk noise. The noise sources of a crosstalk noise are typically disturbing lines transmitting signals through certain frequency bands. The signal powers in the disturbing lines generally are evenly distributed among their transmission frequency band(s) and the locations of the disturbing lines to the disturbed line are also relatively stable. Therefore, the noise power of the crosstalk noise caused by these sources tends to be smoothly distributed in the frequency band(s) of the disturbing lines. As a result, by determining the transmission frequency band(s) of the sources and sampling the crosstalk noise in a few monitoring sub-channels located in these band(s), the receiver can estimate relatively accurately the noise power of the time-varying noise across the transmission frequency band(s) of the disturbed line.

In one embodiment, the monitoring sub-channels for a broadband communication system are selected based on the field deployment scenarios and types of neighboring services that may generate noise affecting communication of the system. For example, if it is known that the phone lines in the transmission line provide ADSL and VDSL services, the communication system can select the monitoring sub-channels in the spectrums used by the ADSL and VDSL services. For example, the spectrum used by ADSL service to transmit data is from 25 kHz to 1.1 MHz. As another example, the VDSL service uses spectrum from 138 kHz to 12 MHz. Assuming the transmission frequency band(s) of the communication system covers the spectrums of these services, the communication system can allocate monitoring sub-channels within the spectrums of the neighboring phone lines. For example, monitoring sub-channels can be located at 30 kHz and 1.09 MHz, within the spectrum of ADSL, and 150 kHz and 11.9 MHz, within the spectrum of VDSL. The communication system can allocate additional monitoring sub-channels outside the spectrums (e.g., at 12.3 MHz). In one embodiment, monitoring sub-channels can be located in the spectrums of each common type of services. It is noted that the communication system does not allocate monitoring sub-channels outside its transmission frequency band(s).

In one embodiment, the receiver uses at least two monitoring channels to determine crosstalk sources. Because a single monitoring sub-channel maybe affected by radio frequency (RF) interference, multiple monitoring sub-channels can make sure that the detected noise is wide-band, thereby not caused by RF signal.

By comparing the noise power observed in the monitoring sub-channels, the receiver can determine the nature of the sources and their transmission frequency band(s). For example, if the noise power of monitoring sub-channels located inside and outside the spectrum of ADSL are substantially the same, the receiver can determine that no crosstalk noise is generated by phone lines carrying ADSL service. As another example, if noise power of the sub-channels located inside the spectrum of VDSL exceeds noise power of the sub-channels outside, the receiver can determine that there are crosstalk noises generated by one or more phone lines carrying VDSL service. If the receiver determines that there are crosstalk noise generated by both ADSL and VDSL services, it can measure the noise power of the monitoring sub-channels in frequency bands overlapped by the two services' spectrums as the collective noise power. If a crosstalk source carries the same service from the same service provider as the disturbed line, the generated crosstalk noise will be appear on each of the monitoring bands.

Because the receiver can determine the nature of the source of the crosstalk noise, it can learn nearby service deployment. In one embodiment, the receiver can dynamically allocate monitoring channels based on this deployment, and optimize the monitoring sub-channel deployment over time to quickly and uniquely identify each of the common time-varying noises.

In one embodiment, the receiver determines the noise power of non-monitoring sub-channels based on the noise power of similarly situated monitoring sub-channels. Two sub-channels are similarly situated if both are within the (or out of) spectrums of the determined crosstalk noise sources. For example, for sub-channels within the ADSL spectrum, if the receiver determines that the crosstalk is caused by the ADSL disturbing line, it will use the noise power of the monitoring sub-channel in the ADSL spectrum as the noise power of these sub-channels. If there are multiple similarly situated monitoring sub-channels, the receiver can use an average value.

The receiver can adjust the data rate of the sub-channels affected by the time-varying noise responding to the noise. For example, for each sub-channel, the receiver can reduce the constellation size responding to an increase of noise power, and increase the constellation size responding to a noise decrease. In one embodiment, the receiver can adjust the data rate using an online reconfiguration (OLR) algorithm. The receiver generates control messages adjusting the constellation sizes and transmits them to the transmitter.

Reliable Communication Channel

The severe noise change caused by crosstalk may render communication unreliable, thus making it impossible to negotiate the data rate change (e.g., adjustment of constellation points) between the receiver and the transmitter. To overcome this, the receiver transmits the control messages through the secondary channel (the reliable communication channel). In one embodiment, the receiver selects a set of reliable sub-channels to collectively form the secondary channel. The reliable sub-channels can be loaded with more noise margin when placed in the frequency band subject to noise increase or they can be loaded with nominal margin but placed in a frequency band immune from noise increase, for example very low frequency band where crosstalk noise coupling is very small.

In one embodiment, the receiver uses one or more monitoring sub-channels for the transmitter to detect and measure time-varying noises as the reliable sub-channels. For example, the secondary channel may comprise exclusively these monitoring sub-channels, even though they are not continuous. Because the monitoring sub-channels are loaded with noise margin higher than noise margin on sub-channels of the primary channel, they are more robust and can be used to transmit control messages.

After receiving the control messages from the receiver, the transmitter can adjust the data rate in the sub-channels of the primary channel accordingly, thereby adapt to the time-varying noise.

The present invention detects time-varying noise in broadband communication promptly and adapts the communication accordingly to minimize the noise's impact, thereby maintaining the transmission at optimal data rate. Since higher noise margin is set only on a few selected sub-channels (monitoring sub-channels and/or reliable sub-channels), the data rate penalty is substantially small compared to a conventional system that applies high noise margin across the transmission frequency band(s). Improved resolution of the noise estimation enables fast adaptation algorithm and finer noise classification to minimize chances of the false noise increase detection.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A method for detecting and adapting to time-varying noise in a DMT-based broadband communication system, comprising:
selecting a set of monitoring sub-channels, the number of monitoring sub-channels is substantially smaller than total number of sub-channels in the system, the noise margins of monitoring sub-channels are higher than the noise margins of non-monitoring sub-channels;
detecting the time-varying noise in the set of monitoring sub-channels;
measuring the time-varying noise in each of the set of monitoring sub-channels;
estimating the time-varying noise in the non-monitoring sub-channels; and
sending a control message to adjust communication in the system responding to the time-varying noise.

2. The method of claim 1, wherein selecting the set of monitoring sub-channels comprises selecting monitoring sub-channels located in spectrums for services that comprise at least one selected from a group consisting of: DSL, ADSL, VDSL, HDSL, and ISDN.

3. The method of claim 1, wherein selecting the set of monitoring sub-channels comprises selecting monitoring sub-channels located in spectrums for services provided in nearby communication lines.

4. The method of claim 1, further comprising:
reselecting the set of monitoring sub-channels based on the noise.

5. The method of claim 1, further comprising:
determining a nature of a source of the detected noise based on the time-varying noise in two or more monitoring sub-channel in the set of monitoring sub-channels.

6. The method of claim 1, wherein sending the control message further comprises sending the control message through a reliable communication channel.

7. The method of claim 6, wherein the reliable communication channel comprises one or more monitoring sub-channels.

8. The method of claim 1, wherein sending a control message comprises sending a control message to adjust data rate in the non-monitoring sub-channels responding to the time varying noise.

9. A network element in a DMT-based broadband communication system, comprising:
a chipset; and
a memory unit comprising a persistent memory that contains microcode for execution by the chipset to cause the chipset to perform the operations,
selecting a set of monitoring sub-channels, the number of monitoring sub-channels is substantially smaller than total number of sub-channels in the system, the noise margins of monitoring sub-channels are higher than the noise margins of non-monitoring sub-channels,
detecting time-varying noise in the set of monitoring sub-channels,
measuring the time-varying noise in each of the set of monitoring sub-channels,
estimating the time-varying noise in the non-monitoring sub-channels, and
sending a control message to adjust communication in the system responding to the time-varying noise.

10. A DMT-based broadband communication system, comprising:
a first network element, wherein the first network element transmits data to a second network element through a set of downstream sub-channels and receives data from the second network element through a first set of upstream sub-channels, wherein the first network element detects and measures time-varying noise through a second set of upstream sub-channels from the first set of upstream sub-channels, the number of the upstream sub-channels in the second set of upstream sub-channels being substantially smaller than the number of the upstream sub-channels in the first set of upstream sub-channels, the noise margin of the upstream sub-channels in the second set of upstream sub-channels being higher than the rest upstream sub-channels in the first set of upstream sub-channels; and
the second network element, wherein the second network element detects and measures time-varying noise through a second set of downstream sub-channels from the first set of downstream sub-channels, the number of the downstream sub-channels in the second set of downstream sub-channels being substantially smaller than the number of the downstream sub-channels in the first set of downstream sub-channels, the noise margin of the downstream sub-channels in the second set of downstream sub-channels being higher than the rest downstream sub-channels in the first set of downstream sub-channels.
